(19) United States
(12) Patent Application Publication
(10) Pub. No.: US 2026/0263990 A1
(43) Pub. Date: Sep. 10, 2026

(54) CARBON DIOXIDE REMOVAL UNIT

(71) Applicant: JOHNSON MATTHEY PUBLIC LIMITED COMPANY, London (GB)

(72) Inventors: William John COTTON, Billingham (GB); Mark Joseph MCKENNA, Billingham (GB); Majid SADEQZADEH BOROUJENI, Billingham (GB)

(21) Appl. No.: 18/873,578

(22) PCT Filed: Aug. 31, 2023
(86) PCT No.: PCT/GB2023/052244

§ 371 Date: Dec. 10, 2024

(30) Foreign Application Priority Data
Sep. 2, 2022 (GB) 2212800.3

(51) Int. Cl. B01D 53/14

(52) U.S. Cl. CPC B01D 53/1475; B01D 53/1425; B01D 53/1493; B01D 2252/204; B01D 2257/504

(57) ABSTRACT

The specification describes a process and apparatus for the removal of carbon dioxide from a synthesis gas. The apparatus comprises an absorber, stripper, and first, second and third heat exchangers. The first heat exchanger and second heat exchanger together provide the reboiling duty for the stripper and are heated with synthesis gas and steam, respectively. A lean absorbent stream is withdrawn from the stripper and cooled in a third heat exchanger with water before being returned to the absorber. This arrangement provides an efficient method for recovery of a CO₂-rich absorbent.

### TECHNICAL FIELD

The invention relates to a carbon dioxide removal unit for the removal of carbon dioxide from a synthesis gas stream.

### BACKGROUND

In many processes it is necessary to remove acid gases, such as CO₂, from a product gas. This is commonly achieved by treating the sour gas, containing the unwanted acid gas, with an absorbent such as an amine in an absorber. The absorbent chemically and/or physically removes the acid gas from the sour gas to produce a CO₂-rich absorbent and sweet gas (CO₂-lean gas).

The absorbent is normally regenerated so it can be reused in the absorber. The regeneration also releases CO₂ which is usually compressed/dehydrated and either transported for storage in underground locations or used for chemicals manufacturing.

WO20101120527A2 (Alstom Technology Ltd) describes a process for removing gaseous contaminants from a gas stream comprising: contacting the gas stream with a wash solution to remove gaseous contaminants from the gas stream by absorption into the wash solution to produce used wash solution; regenerating the used wash solution to remove gaseous contaminants from the used wash solution, to provide a regenerated wash solution and a gas comprising removed contaminants. In a first regeneration stage the gas comprising removed contaminants is cooled to reduce the loss of water vapor. In a preferred embodiment the regenerated wash solution is reboiled to further remove gaseous contaminants and provide a reboiled wash solution. The reboiled wash solution may be used for heat-exchange with regenerated wash solution and with used wash solution.

WO20161123386A1 (Fluor Technologies Corporation) describes a process for carbon dioxide capture from a gas mixture, comprising an absorber, a stripper and a reboiler. The absorbent is a solvent system comprising a chemical solvent and a nonaqueous physical solvent. The stripper receives a CO₂-rich solvent stream from the absorber and produces carbon dioxide and lean solvent through the use of a reboiler in fluid communication with a lower portion of the stripper. In the embodiment described in FIG. 1 of this reference, steam is used for the reboiler duty.

WO2017/029145A1 (Casale SA) describes a CO₂ removal section for removing CO₂ from a hydrogen-containing synthesis gas, comprising an absorption section and a stripper. The stripper comprises an upper zone where the CO₂-rich solution from the absorber is flashed to produce a first gaseous stream containing CO₂ and a partially regenerated semi-lean solution, and a lower zone acting as a stripping zone where the semi-lean solution is stripped producing a second gaseous stream containing CO₂ and a lean regenerated solution. The CO₂ removal section comprises sealing means for isolating the first and second gaseous streams so that they can be exported separately from the stripper. A method of revamping a CO₂ removal unit by introducing the sealing means is also described.

WO2022/008876A1 (Carbon Clean Solutions Limited) describes a method for regenerating a solvent comprising carbon dioxide by passing the solvent comprising carbon dioxide through a low-grade heat regenerator to form a carbon dioxide lean solvent, and passing the carbon dioxide lean solvent through a low-grade heat reboiler. The term “low-grade heat” typically refers to a temperature range of from 60° C. to less than 120° C.

There is a need for further improvements in the energy efficiency of carbon dioxide removal units.

### SUMMARY OF THE INVENTION

The present inventors describe herein a CO₂ removal unit which makes more efficient use of heat streams within the process. The process involves absorption of CO₂ from a synthesis gas in an absorber to generate a CO₂-rich absorbent. The CO₂-rich absorbent is treated in a stripper to remove entrained CO₂ and produce a lean absorbent and CO₂-rich overheads.

A first important feature of the process is that the stripper is able to make use of waste heat from both synthesis gas and steam. In particular, CO₂-rich absorbent is withdrawn from the stripper and subjected to heat exchange in a first heat exchanger using synthesis gas and in a second heat exchanger using steam. The heat exchangers may be arranged in series or in parallel. The steam and synthesis gas together provide the reboiling duty for the stripper, which offers several advantages. The ability to provide the reboiling duty from steam means that the CO₂ removal unit can function even if a synthesis gas stream is not available to provide the full reboiling duty, which is often the case in plants on start-up. This reduces CO₂ emissions during start-up of the plant. Once the portion of the plant which produces synthesis gas is properly running the CO₂ removal unit can switch so that the majority of the heating duty for the stripper is provided by synthesis gas.

A second important feature of the process is that lean absorbent from the stripper is used as a source of low grade heat and is treated by heat exchange to produce hot water and cooled lean absorbent. The hot water is typically produced at around 80° C., and can be used in steam raising equipment. The steam thus raised, may be used as “process steam” e.g. for the reforming and/or water-gas shift reactions, or can be used elsewhere on the plant (“steam export”). The lean absorbent stream therefore provides a significant amount of the heating duty for steam, which would otherwise have to be produced using high grade heat elsewhere in the plant. This arrangement therefore reduces overall energy consumption and associated costs.

In a first aspect the invention relates to a process for the removal of carbon dioxide from a synthesis gas, comprising the steps of:
contacting a synthesis gas and an absorbent in an absorber (101, 201, 301) to produce a CO₂-depleted synthesis gas and a first CO₂-rich absorbent stream (114, 214, 314);
withdrawing the first CO₂-rich absorbent stream from the absorber and transferring the first CO₂-rich absorbent stream to a stripper (102, 202, 302);
withdrawing one or more second CO₂-rich absorbent stream(s) (115, 215a, 215b) from the stripper and heating the one or more second CO₂-rich absorbent stream(s) to separate them into one or more absorbent-depleted CO₂ stream(s) (107a, 107b, 207a, 207b) and one or more CO₂-depleted absorbent stream(s) (108, 208a, 208b) using a first heat exchanger (103, 203, 303) heated with synthesis gas (104a, 204a) and a second heat exchanger (105, 205, 305) heated with steam (106a, 206a);
returning the one or more absorbent-depleted CO₂ stream(s) and one or more CO₂-depleted absorbent stream(s) to the stripper;
withdrawing a gaseous CO₂-rich overheads stream from the stripper; and
withdrawing a lean absorbent stream (109, 209, 309) from the stripper, cooling the lean absorbent stream by heat exchange with water (111, 211, 311) in a third heat exchanger (110, 210, 310) to produce a cooled lean absorbent stream (113, 213, 313), and returning the cooled lean absorbent stream to the absorber;
wherein the first heat exchanger and second heat exchanger are arranged in series or in parallel.

The process is particularly suitable for integration into a process for producing decarbonised synthesis gas (i.e. a mixture of hydrogen and carbon monoxide), H₂, synthetic liquid fuels or ammonia.

In a second aspect the invention relates to an apparatus for the removal of carbon dioxide from a synthesis gas, comprising:
an absorber (101, 201, 301) arranged to contact a synthesis gas with an absorbent to produce a CO₂-depleted synthesis gas and a first CO₂-rich absorbent stream (114, 214, 314);
a stripper (102, 202, 304) arranged to receive the first CO₂-rich absorbent stream from the absorber;
a first heat exchanger (103, 203, 303) arranged to heat a second CO₂-rich absorbent stream (115, 215a) from the stripper using synthesis gas (104a, 204a) in order to separate the second CO₂-rich absorbent stream into an absorbent-depleted CO₂ stream (107a, 207a) and a CO₂-depleted absorbent stream (108b, 208b), and arranged to return the absorbent-depleted CO₂ stream and the CO₂-depleted absorbent stream to the stripper;
a second heat exchanger (105, 205, 305) arranged to heat a second CO₂-rich absorbent from the stripper using steam (106a, 206a) in order to separate the CO₂-rich absorbent into an absorbent-depleted CO₂ stream (107b, 207b) and a CO₂-depleted absorbent stream (108b, 208b), and arranged to return the absorbent-depleted CO₂ stream and the CO₂-depleted absorbent stream to the stripper;
a third heat exchanger (110, 210, 310) arranged to receive a lean absorbent stream (109, 209, 309) from the stripper and to cool the lean absorbent stream using water (111, 211, 311) to produce a cooled lean absorbent stream (113, 213, 313), and arranged to return the cooled lean absorbent stream to the absorber;
wherein the first heat exchanger and second heat exchanger are arranged in series or in parallel.

In a third aspect the invention relates to a chemical plant for the production of decarbonised synthesis gas, H₂, synthetic liquid fuels or ammonia, comprising an apparatus according to the second aspect.

### DESCRIPTION OF THE FIGURES

FIG. 1 is a flow diagram showing an arrangement in which the first and second heat exchangers are arranged in series. A synthesis gas and an absorbent are contacted in an absorber (101) to produce a CO₂-depleted synthesis gas and a first CO₂-rich absorbent stream (114). The first CO₂-rich absorbent stream is sent from the absorber (101) to the stripper (102). A second CO₂-rich absorbent stream (115) is withdrawn from the stripper and fed to a first heat exchanger (103). The heating duty for the first heat exchanger is provided by synthesis gas (104a) which is cooled to produce cooled synthesis gas (104b). Heat exchange between the synthesis gas (104a) and the second CO₂-rich absorbent stream (115) separates the first stream into an absorbent-depleted CO₂ stream (107a) (which is typically a mixture of CO₂ and steam) which is returned to the stripper, and a CO₂-depleted absorbent stream (108a) which is sent to the second heat exchanger (105). The heating duty for the second heat exchanger is provided by steam (106a) which is cooled to produce steam condensate (106b). Heat exchange between steam (106a) and CO₂-depleted absorbent stream (116) further separates the CO₂-depleted absorbent into an absorbent-depleted CO₂ stream (107b) and a CO₂-depleted absorbent stream (108b) which are returned to the stripper. A lean absorbent stream (109) is withdrawn from the stripper and sent to a third heat exchanger (110), where it is cooled using water (111) to produce hot water (112) and a cooled lean absorbent (113) is returned to the absorber.

FIG. 2 is a flow diagram showing an arrangement in which the first and second heat exchangers are arranged in parallel. A first CO₂-rich absorbent stream (214) is sent from the absorber (201) to the stripper (202). A second CO₂-rich absorbent stream (215a) is withdrawn from the stripper and fed to a first heat exchanger (203). The heating duty for the first heat exchanger is provided by synthesis gas (204a), which is cooled to produce cooled synthesis gas (204b). Heat exchange between the synthesis gas (204a) and the second CO₂-rich absorbent stream (215a) separates the second CO₂-rich absorbent stream into an absorbent-depleted CO₂ stream (207a) and a CO₂-depleted absorbent stream (208a) which are returned to the stripper. A second CO₂-rich absorbent stream (215b) is withdrawn from the stripper and fed to a second heat exchanger (205). The heating duty for the second heat exchanger is provided by steam (206a), which is cooled to produce steam condensate (206b). Heat exchange between steam (206a) and the second CO₂-rich absorbent stream (215b) further separates the CO₂-rich absorbent into an absorbent-depleted CO₂ stream (207b) and a CO₂-depleted absorbent stream (208b) which are returned to the stripper. A lean absorbent stream (209) is withdrawn from the stripper and sent to a third heat exchanger (210), where it is cooled using water (211) to produce hot water (212) and a cooled lean absorbent (213) is returned to the absorber.

FIG. 3 is a flow diagram showing an arrangement in which a flash unit is present. A first CO₂-rich absorbent stream (314) is sent from the absorber (301) to the flash unit (316). The flash unit separates out a gaseous CO₂ overheads stream (317) and a semi-lean absorbent stream (318) which is sent to the stripper (302). CO₂-rich absorbent (315) is withdrawn from the stripper and fed to the first and second heat exchangers (303/305) which may be arranged in series or parallel (detail not shown). In some embodiments a gaseous CO₂-rich overheads stream (319) from the stripper may be returned to the flash unit. A lean absorbent stream (309) is withdrawn from the stripper and sent to a third heat exchanger (310), where it is cooled using water (311) to produce hot water (312) and a cooled lean absorbent (313) is returned to the absorber.

In preferred embodiments the cooled lean absorbent (113, 213, 313) is further cooled by air cooling in a fifth heat exchanger before being returned to the absorber.

### DETAILED DESCRIPTION OF THE INVENTION

Any sub-headings are included for convenience only and are not intended to limit the disclosure in anyway.

Any aspect being described in connection with the process is equally applicable to the apparatus and vice versa.

### Absorber

The role of the absorber is the remove CO₂ present in a synthesis gas by contacting the synthesis gas with a liquid absorbent. The synthesis gas fed to the absorber comprises H₂, CO, CO₂, H₂O and may contain unreacted hydrocarbons such as methane. The removal of CO₂ by the absorbent may be achieved by chemical and/or physical absorption and the term “absorbent” is not intended to imply that the absorption is purely chemisorption. A wide variety of absorbents may be used in the present invention, but amine absorbents are particularly preferred. The absorbent may be entirely recycled absorbent (from the cooled lean absorbent stream) but is typically a mixture of recycled absorbent and fresh make-up absorbent.

The absorber produces a CO₂-depleted synthesis gas which can be sent for further treatment (e.g. purification and/or compression) and a first CO₂-rich absorbent stream. The first CO₂-rich absorbent stream is sent for regeneration by the stripper, or where a flash unit is present, by the flash unit and stripper.

The CO₂-depleted synthesis gas may be used downstream to produce H₂, synthetic liquid fuels, ammonia or other chemicals.

### Flash Unit

The apparatus may include a flash unit located between the absorber and the stripper. The flash unit is arranged to separate the first CO₂-rich absorbent stream from the absorber into a CO₂ overheads stream and a semi-lean absorbent stream by pressure change, and is arranged to send the semi-lean absorbent stream to the stripper where it is separated into a gaseous CO₂-rich overheads stream and a lean absorbent stream.

In some embodiments the apparatus is arranged to split the semi-lean absorbent stream from the flash unit into a first portion which is sent to the stripper and a second portion which is sent to the absorber. This can be beneficial because it reduces the overall reboiling energy requirement, reduces absorbent degradation, and offers flexibility in case of variation in syngas operating conditions.

In a preferred embodiment the semi-lean absorbent stream is heated by heat exchange with the lean absorbent stream from the stripper before entering the stripper. This arrangement allows for more efficient heat usage.

### Stripper

The role of the stripper is to separate the first CO₂-rich absorbent stream, or the semi-lean absorbent stream in the case where the flash unit is present, into a CO₂-rich overheads stream and a lean absorbent stream. This is achieved by the use of a first heat exchanger and a second heat exchanger. The first and second heat exchangers may be arranged in series or in parallel.

One or more second CO₂-rich absorbent stream(s) are withdrawn from the stripper. The term “second” is simply to differentiate this stream from the first CO₂-rich absorbent stream described previously in connection with the absorber. Typically, one second CO₂-rich absorbent stream is withdrawn when the heat exchangers are arranged in series, while two second CO₂-rich absorbent streams are withdrawn when the heat exchangers are arranged in parallel.

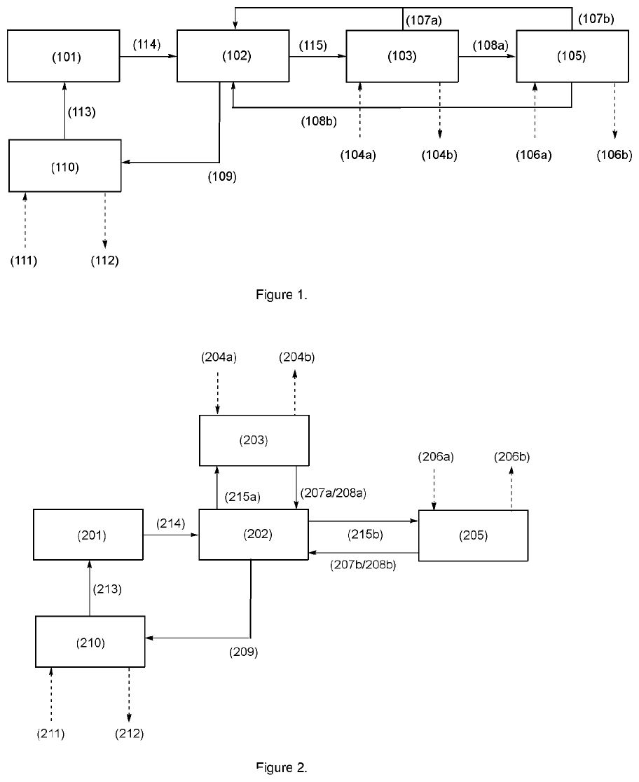

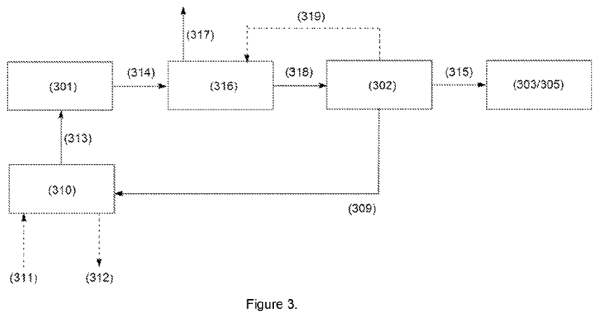

In a series arrangement a second CO₂-rich absorbent stream is withdrawn from the stripper to the first heat exchanger where it is heated using synthesis gas, in order to separate it into an absorbent-depleted CO₂ stream and a CO₂-depleted absorbent stream. The absorbent-depleted CO₂ stream, which is typically a mixture of CO₂ and steam containing low or negligible amounts of absorbent, is returned to the stripper. The CO₂-depleted absorbent stream is sent to the second heat exchanger where it is heated using steam, in order to generate a further absorbent-depleted CO₂ stream and a further CO₂-depleted absorbent stream, which are returned to the stripper. An exemplary arrangement is shown in FIG. 1. In a series arrangement it is also possible for the second heat exchanger (using steam) to be arranged first, followed by the first heat exchanger (using synthesis gas). If the steam and syngas are at different temperatures then the heat exchanger with the cooler heat exchange medium should be arranged first, followed by the heat exchanger using the hotter heat exchange medium.

In a parallel arrangement two second CO₂-rich absorbent streams are withdrawn from the stripper. The second CO₂-rich absorbent stream is heated in the first heat exchanger using synthesis gas, in order to separate it into an absorbent-depleted CO₂ stream and a CO₂-depleted absorbent stream, which are returned to the stripper. An analogous process occurs in the second heat exchanger using steam. An exemplary arrangement is shown in FIG. 2.

Although referred to herein as an “absorbent-depleted CO₂ stream” this stream will typically contain significant amounts of steam, and steam may be the major component of this stream. The separation of the second CO₂-rich absorbent stream(s) into absorbent-depleted CO₂ stream(s) and CO₂-depleted absorbent stream(s) may also be referred to as “reboiling”, with syngas and steam together providing the reboiling duty.

The first and second heat exchangers provide the heat duty for regenerating the CO₂-rich absorbent using synthesis gas and steam respectively. The relative proportion of heat duty provided by the first and second heat exchangers may be changed over time. For example, at start-up the second heat exchanger may provide most of the heat duty while at steady state most of the heat duty is provided by the first heat exchanger.

During steady operation syngas provides the majority of the heating duty for the stripper, therefore is preferred that if the first and second heat exchangers are arranged in series then the order is: first heat exchanger (heated by syngas) followed by second heat exchanger (heated by steam). This arrangement allows the amount of steam to be controlled to meet the remaining reboiling duty.

The first and second heat exchangers may be located within or outside of the stripper and the term “withdrawing CO₂-rich absorbent from the stripper” should be understood accordingly. It is preferred that the heat exchangers are located outside of the stripper because this arrangement is less complex and more reliable.

The temperature of the synthesis gas and steam fed to the first and second heat exchangers should be high enough to cause desorption of the CO₂ from the CO₂-rich absorbent. Typically the synthesis gas fed to the first heat exchanger is at least 100° C., such as 120 to 200° C., preferably 130 to 170° C. Typically the steam fed to the first heat exchanger is at least 100° C., such as 120 to 200° C., preferably 120 to 130° C.

A CO₂-rich overhead stream is removed from the top of the stripper. These overheads may be sent for further processing downstream, e.g. CO₂ compression and dehydration optionally followed by CO₂ transport and storage. Where a flash unit is present the CO₂-rich overhead stream is preferably returned to the flash unit.

### Return to Absorber

A lean absorbent stream is withdrawn from the stripper, typically from the bottom of the stripper. This lean absorbent stream needs to be cooled before being returned to the absorber because absorption in the absorber is more efficient when the absorbent is cool. The lean absorbent stream is therefore cooled in a third heat exchanger using water. The water provided to the third heat exchanger is at a temperature less than that of the lean absorbent stream, and is typically provided at around 20° C. (e.g. 10-35° C.) and is heated to about 80° C. (e.g. 70-90° C.) by heat exchange with the lean absorbent stream. The water is preferably demineralised water. The products from the third heat exchanger are a cooled lean absorbent stream and a hot water stream.

The use of water to cool the lean absorbent stream reduces the duty on cooling unit for the absorber recycle. The use of low grade heat from the lean absorbent stream to produce a hot water stream improves the overall plant efficiency. The hot water stream can subsequently be used to generate steam, which may be used as reactant for steam reforming and/or water-gas shift reactions elsewhere on the plant, e.g. in a steam methane reformer (SMR), autothermal reformer (ATR) or water-gas shift unit, or may be exported e.g. “steam export”. Steam would otherwise have to be produced using high grade heat from elsewhere.

In some embodiments the apparatus comprises a fifth heat exchanger arranged to further cool the cooled lean absorbent stream from the third heat exchanger by air cooling. This is preferable in order to cool the absorbent as much as possible before it is returned to the absorber. A further benefit of cooling the lean absorbent stream in the fifth heat exchanger using water is that may allow for a smaller air cooler to be used. This reduces operating costs compared to an arrangement where cooling of the lean absorbent is achieved entirely by air cooling.

In some embodiments, where a flash unit is present, the apparatus comprises a fourth heat exchanger arranged to receive lean absorbent from the stripper and semi-lean absorbent from the flash unit. Lean absorbent from the stripper is cooled by heat exchange with semi-lean absorbent from the flash unit.

### EXAMPLE

A simulation was carried out on the arrangement shown in FIG. 2. The lean absorbent stream (209) withdrawn from the stripper had very low levels of residual CO₂. Cooling of the lean absorbent stream in heat exchanger (210) generated a hot water stream (212) at temperature of 79° C. which can be used for steam export.

| Stream Number | | 204a | 204b | 206a | 206b | 207a | 207b | 208a | 208b |
|---|---|---|---|---|---|---|---|---|---|
| Molar Flow | kNm³/h | 201.9 | 201.9 | 11.6 | 11.6 | 35.9 | 10.0 | 450.0 | 125.8 |
| Mass Flow | t/h | 126.1 | 126.1 | 9.3 | 9.3 | 31.3 | 8.8 | 392.8 | 109.8 |
| Temperature | ° C. | 169 | 130 | 135 | 130 | 119 | 119 | 119 | 119 |
| Pressure | bara | 32.9 | 32.6 | 2.7 | 2.7 | 1.8 | 1.8 | 1.8 | 1.8 |
| Molar Composition | Unit | | | | | | | | |
| Methane | mol % | 0.38 | 0.38 | — | — | — | — | — | — |
| Ethane | mol % | 0.00 | 0.00 | — | — | — | — | | — |
| Propane | mol % | 0.00 | 0.00 | — | — | — | — | — | — |
| Butanes | mol % | 0.00 | 0.00 | — | — | — | — | | — |
| Pentanes | mol % | 0.00 | 0.00 | — | — | — | — | — | |
| Hydrogen | mol % | 55.58 | 55.58 | — | — | — | — | — | — |
| Carbon Dioxide | mol % | 18.47 | 18.47 | — | — | 1.40 | 1.40 | 0.19 | 0.19 |
| Carbon Monoxide | mol % | 0.49 | 0.49 | — | — | — | — | — | — |
| Oxygen | mol % | 0.00 | 0.00 | — | — | — | — | | — |
| Nitrogen | mol % | 0.16 | 0.16 | — | — | — | — | — | — |
| Argon | mol % | 0.04 | 0.04 | — | — | — | — | — | — |
| Water | mol % | 24.82 | 24.82 | 100.00 | 100.00 | 98.42 | 98.42 | 88.35 | 88.35 |
| Methanol | mol % | 0.05 | 0.05 | — | — | 0.09 | 0.09 | 0.02 | 0.02 |
| Ammonia | mol % | 0.01 | 0.01 | — | — | — | — | — | — |
| Absorbent | mol % | — | — | — | — | 0.09 | 0.09 | 11.44 | 11.44 |

| Stream Number | | 209 | 211 | 212 | 213 | 214 | 215a | 215b |
|---|---|---|---|---|---|---|---|---|
| Molar Flow | kNm³/h | 575.9 | 42.7 | 42.7 | 577.2 | 1611.4 | 485.9 | 135.8 |
| Mass Flow | t/h | 502.7 | 34.3 | 34.3 | 503.8 | 1432.3 | 424.1 | 118.6 |
| Temperature | ° C. | 119 | 20 | 79 | 50 | 89 | 119 | 119 |
| Pressure | bara | 1.8 | 5.0 | 4.5 | 33.5 | 32.5 | 1.8 | 1.8 |
| Molar Composition | Unit | | | | | | | |
| Methane | mol % | — | — | — | — | — | — | — |
| Ethane | mol % | — | — | — | — | — | — | — |
| Propane | mol % | — | — | — | — | — | — | — |
| Butanes | mol % | — | — | — | — | — | — | — |
| Pentanes | mol % | — | — | — | — | — | — | — |
| Hydrogen | mol % | — | — | — | — | 0.02 | — | — |
| Carbon Dioxide | mol % | 0.19 | — | — | 0.19 | 4.97 | 0.28 | 0.28 |
| Carbon Monoxide | mol % | — | — | — | — | — | — | — |
| Oxygen | mol % | — | — | — | — | — | — | — |
| Nitrogen | mol % | — | — | — | — | — | — | — |
| Argon | mol % | — | — | — | — | — | — | — |
| Water | mol % | 88.35 | 100.00 | 100.00 | 88.35 | 84.36 | 89.09 | 89.09 |
| Methanol | mol % | 0.02 | — | — | 0.02 | 0.02 | 0.02 | 0.02 |
| Ammonia | mol % | — | — | — | — | — | — | — |
| Absorbent | mol % | 11.44 | — | — | 11.44 | 10.63 | 10.60 | 10.60 |

1. A process for the removal of carbon dioxide from a synthesis gas, comprising the steps of:
contacting a synthesis gas and an absorbent in an absorber to produce a CO₂-depleted synthesis gas and a first CO₂-rich absorbent stream;
withdrawing the first CO₂-rich absorbent stream from the absorber and transferring the first CO₂-rich absorbent stream to a stripper;
withdrawing one or more second CO₂-rich absorbent stream(s) from the stripper and heating the one or more second CO₂-rich absorbent stream(s) to separate them into one or more absorbent-depleted CO₂ stream(s) and one or more CO₂-depleted absorbent stream(s) using a first heat exchanger heated with synthesis gas and a second heat exchanger heated with steam;
returning the one or more absorbent-depleted CO₂ stream(s) and one or more CO₂-depleted absorbent stream(s) to the stripper;
withdrawing a gaseous CO₂-rich overheads stream from the stripper; and
withdrawing a lean absorbent stream from the stripper, cooling the lean absorbent stream by heat exchange with water in a third heat exchanger to produce a cooled lean absorbent stream, and returning the cooled lean absorbent stream to the absorber;
wherein the first heat exchanger and second heat exchanger are arranged in series or in parallel.

2. The process according to claim 1, wherein the first CO₂-rich absorbent stream is sent to a flash unit located between the absorber and the stripper, separating the first CO₂-rich absorbent stream into a gaseous CO₂ overheads stream and a semi-lean absorbent stream, and sending the semi-lean absorbent stream to the stripper.

3. The process according to claim 2, wherein a gaseous CO₂-rich overheads stream from the stripper is returned to the flash unit.

4. The process according to claim 2, wherein the semi-lean absorbent stream is split and a first portion is sent to the stripper while a second portion is sent to the absorber.

5. The process according to claim 2, wherein the lean absorbent stream from the stripper is cooled by heat exchange with the semi-lean absorbent stream from the flash unit in a fourth heat exchanger.

6. The process according to claim 1, wherein the cooled lean absorbent stream from the third heat exchanger is further cooled in a fifth heat exchanger by air cooling.

7. The process according to claim 1 wherein the first heat exchanger and second heat exchanger are arranged in parallel.

8. The process according to claim 1, wherein the first heat exchanger and second heat exchanger are arranged in series.

9. The process according to claim 1, wherein the temperature of the synthesis gas fed to the first heat exchanger is at least 100° C.

10. The process according to claim 1, wherein the temperature of the steam fed to the second heat exchanger is at least 100° C.

11. The process according to claim 1, wherein a hot water stream generated by the third heat exchanger is used to generate steam.

12. The process according to claim 1, wherein the absorbent is an amine.

13. The process according to claim 1, wherein the CO₂-depleted synthesis gas is used downstream for the production of H₂, synthetic liquid fuels, ammonia or other chemicals.

14. An apparatus for the removal of carbon dioxide from a synthesis gas, comprising:
an absorber arranged to contact a synthesis gas with an absorbent to produce a CO₂-depleted synthesis gas and a first CO₂-rich absorbent stream;
a stripper arranged to receive the first CO₂-rich absorbent stream from the absorber;
a first heat exchanger arranged to heat a second CO₂-rich absorbent stream from the stripper using synthesis gas in order to separate the second CO₂-rich absorbent stream into an absorbent-depleted CO₂ stream and a CO₂-depleted absorbent stream, and arranged to return the absorbent-depleted CO₂ stream and the CO₂-depleted absorbent stream to the stripper;
a second heat exchanger arranged to heat a second CO₂-rich absorbent from the stripper using steam in order to separate the CO₂-rich absorbent into an absorbent-depleted CO₂ stream and a CO₂-depleted absorbent stream and arranged to return the absorbent-depleted CO₂ stream and the CO₂-depleted absorbent stream to the stripper;
a third heat exchanger arranged to receive a lean absorbent stream from the stripper and to cool the lean absorbent stream using water to produce a cooled lean absorbent stream, and arranged to return the cooled lean absorbent stream to the absorber;
wherein the first heat exchanger and second heat exchanger are arranged in series or in parallel.

15. The apparatus according to claim 14, comprising a flash unit located between the absorber and the stripper, arranged to separate the first CO₂-rich absorbent stream from the absorber into a CO₂-overheads stream and a semi-lean absorbent stream in the flash unit, and arranged to send semi-lean absorbent to the stripper.

16. The apparatus according to claim 15, arranged to return CO₂-rich overheads from the stripper to the flash unit.

17. The apparatus according to claim 15, arranged to split semi-lean absorbent from the flash unit into a first portion sent to the stripper and a second portion sent to the absorber.

18. The apparatus process according to claim 15, comprising a fourth heat exchanger arranged to receive lean absorbent from the stripper and semi-lean absorbent from the flash unit and to cool the lean absorbent.

19. The apparatus according to claim 14, comprising a fifth heat exchanger arranged to further cool the cooled lean absorbent from the third heat exchanger by air cooling.

20. The apparatus according to claim 14, wherein the first heat exchanger and second heat exchanger are arranged in parallel.

21. The apparatus according to claim 14, wherein the first heat exchanger and second heat exchanger are arranged in series.

22. A chemical plant for the production of decarbonised synthesis gas, H₂, synthetic liquid fuels ammonia or other chemicals, comprising an apparatus according to claim 14.
